(19) United States
(12) Patent Application Publication
(10) Pub. No.: US 2004/0186910 A1
(43) Pub. Date: Sep. 23, 2004

(54) Network of data processor controlled display stations sharing network connected resources with immediate messaging on the station's display and apparatus for preventing message intrusion when running selected computer programs

(75) Inventors: Susann Marie Keohane, Austin, TX (US); Gerald Francis McBrearty, Austin, TX (US); Shawn Patrick Mullen, Buda, TX (US); Jessica Kelley Murillo, Hutto, TX (US); Johnny Meng-Han Shieh, Austin, TX (US)

Correspondence Address: Mark McBurney, International Business Machines Corporation, Intellectual Property Law Dept., Internal Zip 4054, 11400 Burnet Road, Austin, TX, 78758, US

(73) Assignee: International Business Machines Corporation, Armonk, NY

(21) Appl. No.: 10/392,761

(22) Filed: Mar. 19, 2003

(51) Int. Cl. G06F 15/16

(52) U.S. Cl. 709/229; 709/206

(57) ABSTRACT

An implementation for giving the user more options for tailoring the intrusive interface messaging to the user needs by providing a system, method and program wherein the user in a computer managed network of a plurality of data processor controlled interactive display stations, has the option of selectively preventing data transmitted to a receiving display station from intruding on selected programs running on the user interface display of said receiving display station. Apparatus for loading programs into one of the receiving display stations has an associated interactive implement enabling a user at the receiving display station to designate any of the programs being loaded as not to be disturbed. There is apparatus for running any of the loaded programs on the receiving display station, apparatus for transmitting data to be displayed on the receiving display station during the running of any of such loaded programs and apparatus for preventing the transmitted data from being displayed when said program being run has been designated as not to be disturbed.

### TECHNICAL FIELD

The present invention relates to implementations for facilitating “ease of use” for the interactive computer user in the present day highly mobile office environment in which the users share networked resources and work functions, and frequently have to be available 24 hours a day for messages relative to such an environment.

### BACKGROUND OF THE RELATED ART

The 1990's have been marked by a technological revolution driven by the convergence of the data processing industry with the consumer electronics industry. The effect has, in turn, driven technologies that have been known and available but relatively quiescent over the years. A major one of these technologies is the Internet or World Wide Web (Web) related distribution of documents, programs, media and all other data processing entities. The convergence of the electronic entertainment and consumer industries with data processing exponentially accelerated the demand for wide ranging communication distribution channels and the Web or Internet, which had quietly existed for over a generation as a loose academic and government data distribution facility, reached “critical mass” and commenced a period of phenomenal expansion.

As a result of this expansion, extraordinary worldwide communication channels and resources have become available to businesses, and this has commenced an era that should forever change how business processes are conducted. The era is marked by what may be referred to as “virtual enterprises”, i.e. businesses relying on networked shared processes for the distribution of work and resources to conduct their business. Conventionally, business processes have been carried out completely within the limits of a company. The processes began and were completed within the company boundaries. However, in the present electronic business environment, the “company under one roof” facilities have been diminishing as employees work from home, on the road, etc., and the roof has become the widening network umbrella. In this highly mobile business pervasive computing paradigm where users often “office” out of little more than their briefcase, it is more and more likely that a user will need to access his information from the Web or Internet or his private network at many different receiving display stations. In addition, the environment often does not permit messages to wait until the user “gets back to office”. Despite its many benefits, this environment has given rise to the annoying and frequently disruptive problem of dealing with messages that, in the case of busy users, seem to continuously intrude upon and, at least partially, cover the user's computer display workspace or desktop interface.

Even in the case of less important messages, the user is then forced to stop what he is doing with respect to programs active on the desktop interface and get rid of the message. Sometimes this is not very easy. Some computer interface desktop environments may require several manipulations to eliminate an intrusive message or dialog box. This may, at times, cause the user to lose track of where he is with respect to desktop work or even cause erroneous entries in unforgiving computer display interfaces.

In addition, there may be circumstances with some of the particular user's application programs where it is critical that there be no display interface interruptions for messaging.

While intrusive messaging on display interfaces is a critical requirement of today's mobile office/electronic business environment, the industry is seeking new expedients to give the user more options for tailoring the intrusive interface messaging to the user's needs.

### SUMMARY OF THE PRESENT INVENTION

The present invention offers an implementation for giving the user more options for tailoring the intrusive interface messaging to the user's needs by providing a system, method and program wherein the user in a computer managed network of a plurality of data processor controlled interactive display stations has the option of selectively preventing message data transmitted to a receiving display station from intruding on selected programs running on the user interface display of said receiving display station.

The invention involves the combination of apparatus for loading functional programs into one of the receiving display stations, and an interactive implement enabling a user at the receiving display station to designate any of the programs being loaded as not to be disturbed. The combination further includes apparatus for running any of the loaded programs on the receiving display station, apparatus for transmitting data to be displayed on the receiving display station during the running of any of such loaded programs and apparatus for preventing the transmitted data from being displayed when said program being run has been designated as not to be disturbed.

The invention may function effectively in an environment in which a plurality of computer resources connected to the network and shared by the interactive display stations and wherein the transmitted data relates to the shared computer resources. This network may, of course, be the Internet or Web (the terms are used interchangeably in this description).

Preferably the implement enabling the interactive user to designate a loaded program as not to be disturbed applies the “Not to be Disturbed” designation as a default attribute as the program is being loaded.

The invention may effectively be used in an environment where one of said shared resources is an instant messaging system and any one of the other interactive display stations is enabled to transmit said data to be displayed in the form of an electronic message to the receiving display station.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of implementing the receiving display station on a network in accordance with the present invention;

FIG. 2 is a generalized diagrammatic view of a network (World Wide Web) portion upon which the present invention may be implemented;

FIG. 3 is a diagrammatic illustration of a display screen showing a user interactive display interface on a data processor controlled display station during the loading or installation of a computer program in accordance with the present invention;

FIG. 4 is a diagrammatic illustration of a display screen interface like that of FIG. 3 at a subsequent program installation stage;

FIG. 5 is the display interface of FIG. 3 at a yet further program installation stage;

FIG. 6 is a display interface like that of FIG. 3 but during the subsequent running of a computer program that has been designated as Not to be Disturbed;

FIG. 7 is a general flowchart of a program set up to implement the present invention for selectively preventing data transmitted to a receiving display station from intruding on selected programs running on the user interface display of said receiving display station; and

FIG. 8 is a flowchart of an illustrative run of the program set up in FIG. 7.

### DETAILED DESCRIPTION OF THE PREFERRED EMBODIMENT

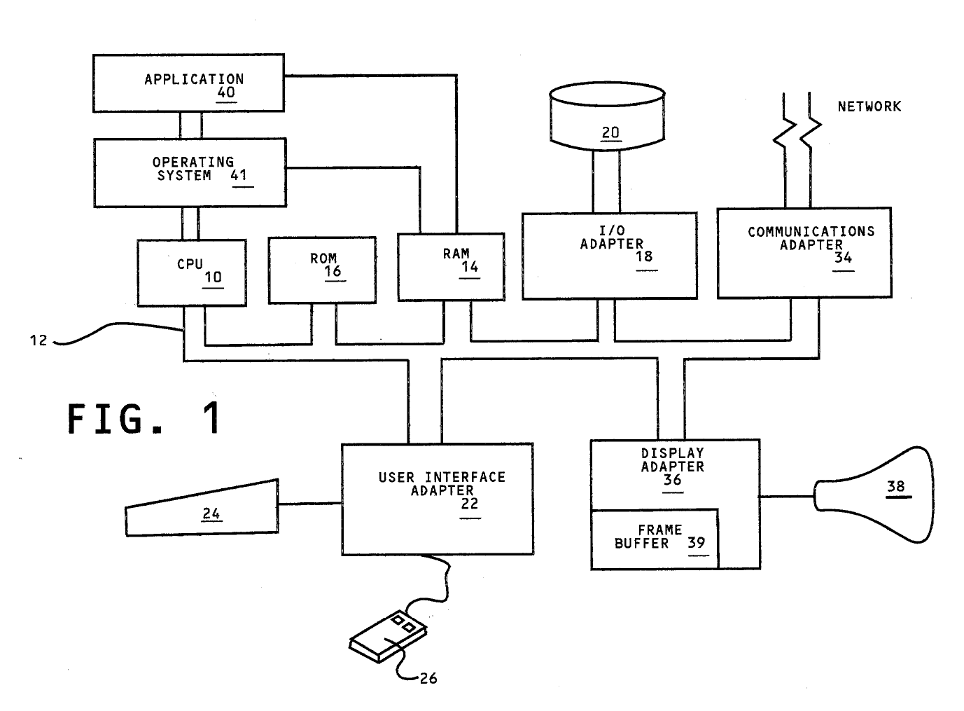

Referring to FIG. 1, a typical data processing terminal is shown that may function as a basic computer controlled network receiving terminal used in implementing the present invention for selectively preventing data transmitted to a receiving display station from intruding on selected programs running on the user interface display of said receiving display station. A central processing unit (CPU) 10, such as one of the PC microprocessors or workstations; e.g. RISC System/6000™ series available from International Business Machines Corporation (IBM), or Dell PC microprocessors is provided and interconnected to various other components by system bus 12. An operating system 41 runs on CPU 10, provides control and is used to coordinate the function of the various components of FIG. 1. Operating system 41 may be one of the commercially available operating systems; such as IBM's AIX 6000™ operating system or Microsoft's WindowsXP™ or Windows2000™, as well as UNIX and other IBM AIX operating systems. Application programs 40, controlled by the system, are moved into and out of the main memory Random Access Memory (RAM) 14. These programs include the program of the present invention that will be described hereinafter. A Read Only Memory (ROM) 16 is connected to CPU 10 via bus 12 and includes the Basic Input/Output System (BIOS) that controls the basic computer functions. RAM 146 I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside Internet or Web network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to the desktop or workspace display interface in doing work using a variety of application programs, including the installation of such programs and the selective designation of selected programs as “Not to be Disturbed” by messages during their runs.

Display adapter 36 includes a frame buffer 39 that is a storage device that holds a representation of each pixel oh the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments it will be helpful to understand from a more general perspective the various elements and methods that may be used to illustrate the present invention. Since an aspect of the present invention is directed to documents such as Web pages transmitted over networks, an understanding of networks and their operating principles would be helpful. We will not go into great detail in describing the networks to which the present invention is applicable. In electronic business and its attendant sharing of work functions global networks, such as the Internet or Web, may be involved. For details on Internet nodes, objects and links, reference is made to the text, Mastering the Internet, G. H. Cady et al., published by Sybex Inc., Alameda, Calif., 1996.

The Internet or Web is a global network of a heterogeneous mix of computer technologies and operating systems. Higher level objects are linked to the lower level objects in the hierarchy through a variety of network server computers. These network servers are the key to network distribution, such as the distribution of Web pages and related documentation. Web documents are conventionally implemented in HTML language, which is described in detail in the text entitled Just Java, van der Linden, 1997, SunSoft Press, particularly at Chapter 7, pp. 249-268, dealing with the handling of Web pages; and also in the above-referenced Mastering the Internet, particularly at pp. 637-642, on HTML in the formation of Web pages.

In addition, aspects of this invention will involve Web browsers. A general and comprehensive description of browsers may be found in the above-mentioned Mastering the Internet text at pp. 291-313. More detailed browser descriptions may be found in the above-mentioned Internet: The Complete Reference, Millennium Edition text: Chapter 19, pp. 419-454, on the Netscape Navigator; Chapter 20, pp. 455-494, on the Microsoft Internet Explorer; and Chapter 21, pp. 495-512, covering Lynx, Opera and other browsers.

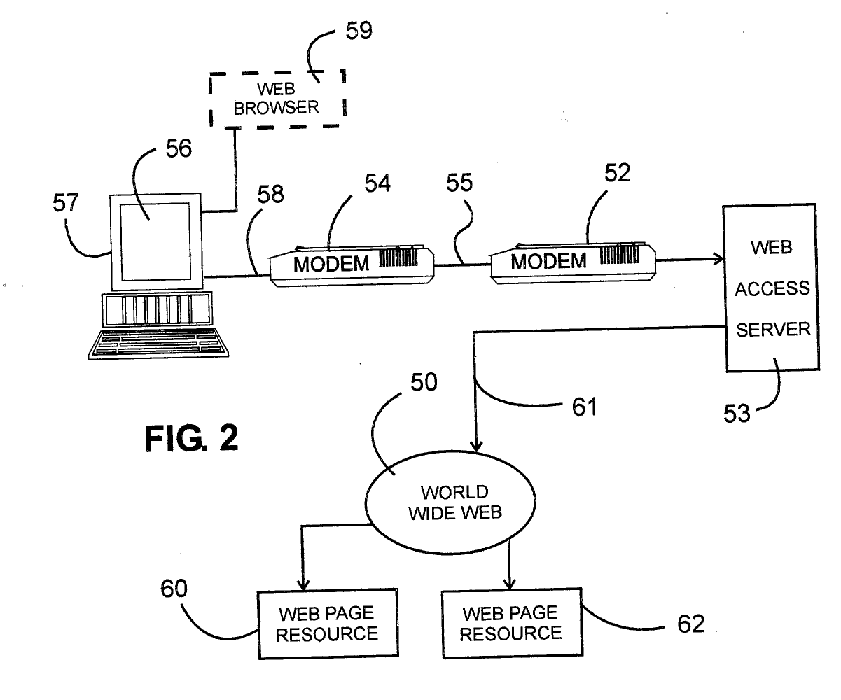

While the present invention may be effectively used in a private network environment, for convenience in illustration a generalized portion of the Web as shown in FIG. 2 will be used. A generalized diagram of a portion of the Web that the computer controlled display terminal 57 used for Web page receiving is connected as shown in FIG. 2. Computer display terminal 57 may be implemented by the computer system set up in FIG. 1 and connection 58 (FIG. 2) is the network connection shown in FIG. 1. For purposes of the present embodiment computer 57 serves as a Web display station and is functioning running programs in a desktop or workspace environment on display 56. What is displayed may be electronic business documents in the form of e-mail or other Web documents the computer programs may be running with respect to such received documents. Computer 57/display 56 may be portable in the present mobile office environment. Likewise, the intrusive messaging toward which this invention is directed would be likewise transmitted over the network.

A generalized diagram of a portion of the Internet, which the computer 57 controlled display terminal used for Web document 56 or other document display of the present invention, is connected as shown in FIG. 2. Display terminal 57 with Web page displays are the computer system shown in FIG. 1 and connection 58 (FIG. 2) is the network connection shown in FIG. 1. Reference may be made to the above-mentioned Mastering the Internet, pp. 136-147, for typical connections between local display workstations to the Internet via network servers, any of which may be used to implement the system on which this invention is used. The system embodiment of FIG. 2 is one of these known as a host-dial connection. Such host-dial connections have been in use for over 30 years through network access servers 53 that are linked 51 to the Internet 50. High speed cable modems are now replacing the telephone lines. The servers 53 are maintained by a service provider to the client's display terminal 57. The host's server 53 is accessed by the client terminal 57 through a normal dial-up telephone or high speed cable linkage 58 via modem 54, line 55 and modem 52. The files representative of the Web pages, e-mail or messages are downloaded to display terminal 57 through controlling server 53 via the telephone or cable line linkages from server 53 that has accessed them from the Internet 50 via linkage 61. Web browser 59 controls the Web page/e-mail accessing and messaging display functions being described, including communications to and from resources 60 and 62 via Web 50.

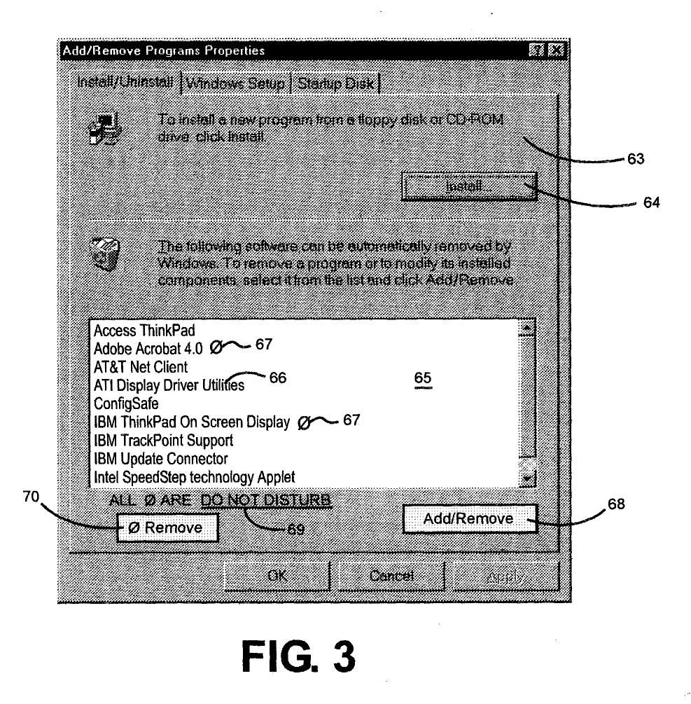

With reference, to FIG. 3, there is shown a display screen interactive dialog panel 63 at an initial installation stage for a variety of application programs. This a typical installation panel that may be found and used for the installation of an application program in a windows environment. The panel 63 contains a scrollable window 65 that lists all of the application programs 66 installed in the system. In accordance with the present invention, as will be hereinafter described, some of the listed programs are designated with a bar-circle icon 67 that indicates that such programs are “Do Not Disturb” as indicated in explanation 69. There are also buttons 68 via which any scrolled-to designated program on the list may be deleted, i.e. removed. Also, button 70 may be used to remove the bar-circle icon from a scrolled-to program to thereby render such program no longer in the do not disturb category.

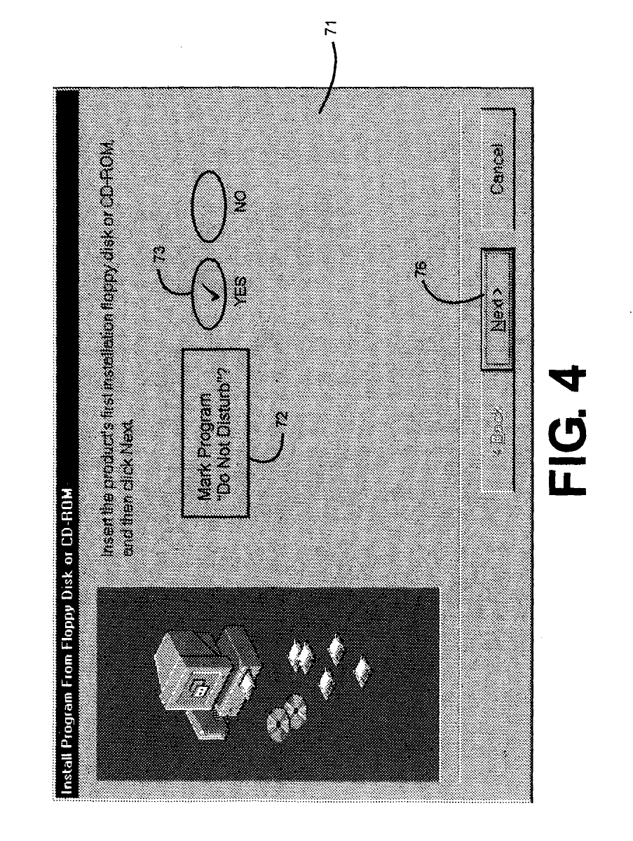

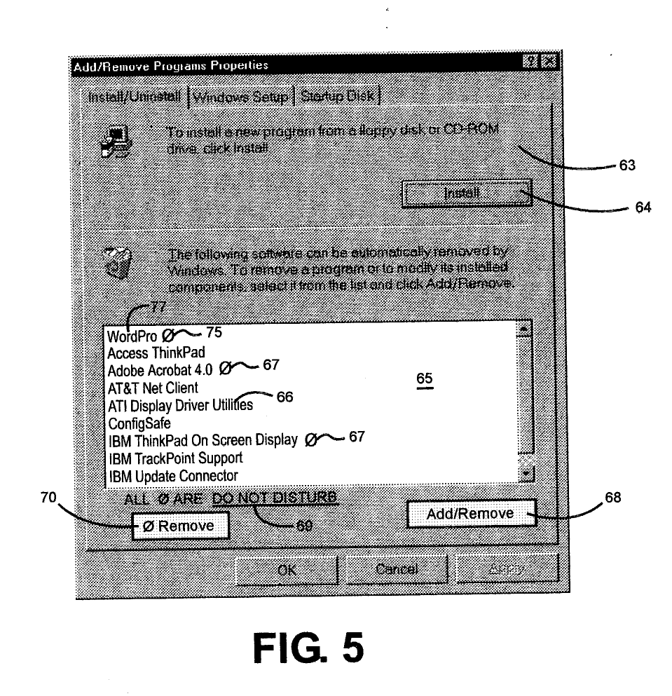

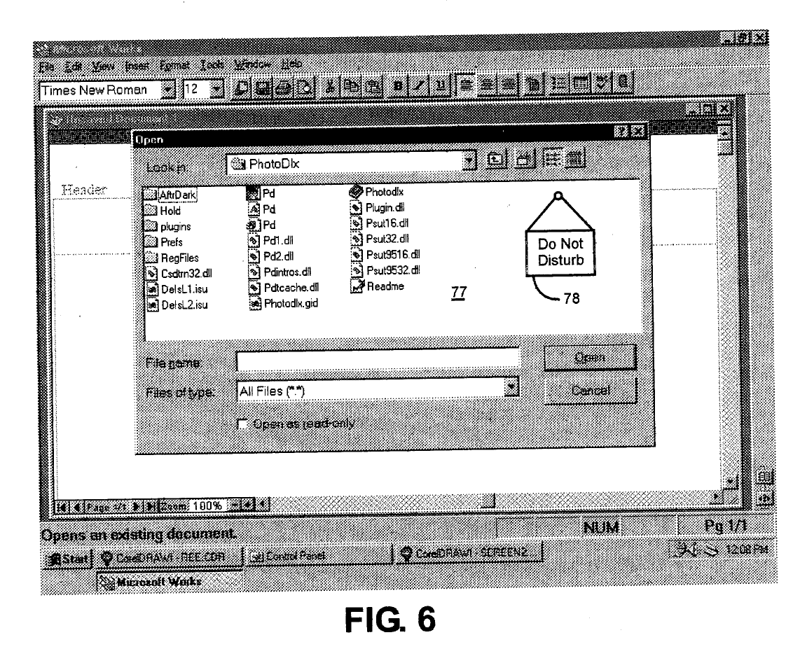

Now, assuming that a new application program is to be installed, the user clicks on the Install button to bring up the display panel 71 shown in FIG. 4. As indicated, the program is then installed from a disk or CD-ROM. During such installation, the user is prompted to indicate whether the program is to be “Do Not Disturb”, and is given Yes 73/No ovals to select. With the present program, the user has selected Yes 73. He then clicks on Next 76 to complete the installation. At this point, the installation process returns to panel 63, FIG. 5, where the installed program, “WordPro” 77 is shown on the program list 66 as designated by icon 75 to indicate that the program is one that will operate in the Do Not Disturb mode, i.e. no incoming messages will be displayed. Panel 77, FIG. 6, illustrates this operation of a program on a desktop or workspace in the Do Not Disturb mode as indicated by icon 78. No received messages will be permitted to be displayed during any run of this WordPro program. Should the user decide to remove the WordPro program from this mode, he would have to return to installation panel 63, FIG. 5, scroll to the WordPro program 77 and click on the Remove button 70. This would return the WordPro program to a normal run state wherein messages could be displayed during its running.

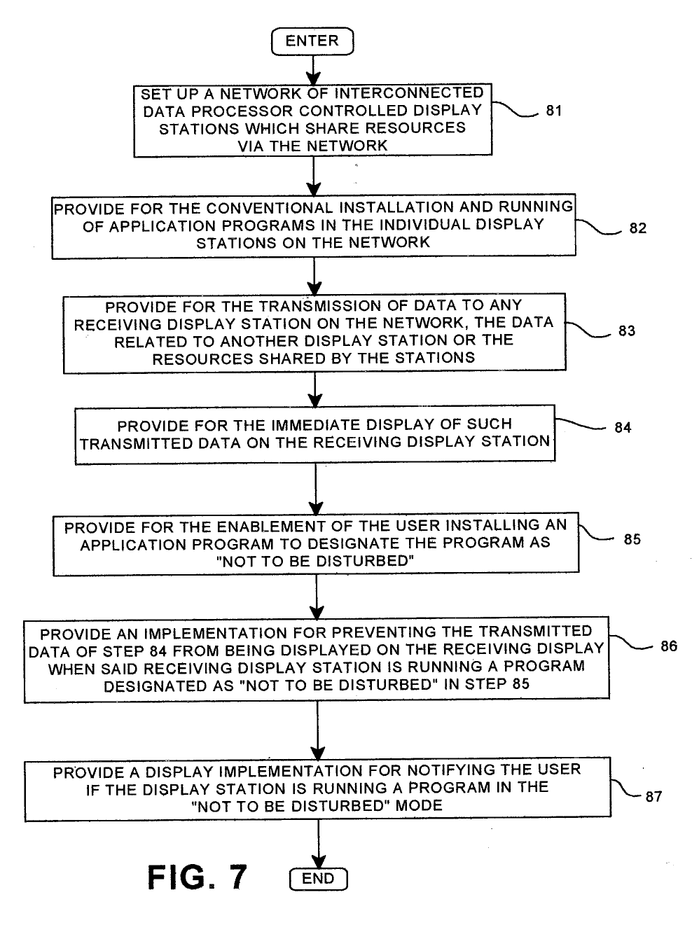

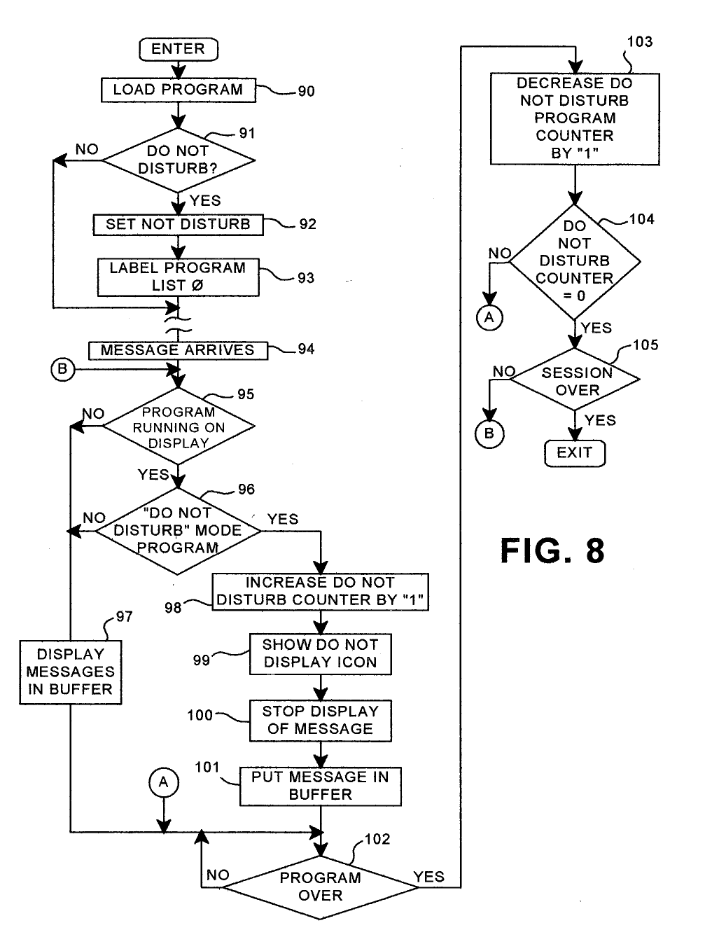

Now, with reference to FIGS. 7 and 8, we will describe a process implemented by the present invention in conjunction with the flowcharts of these figures. FIG. 7 is a flowchart showing the development of a process according to the present invention for selectively preventing data transmitted to a receiving display station from intruding on selected programs running on the user interface display of said receiving display station. With reference to FIG. 7, first, process step 81, there is a network environment of interconnected data processor controlled display stations that share resources and work functions via the network. Conventional provision for the installation and running of application programs is available within the individual display stations of the network, step 82. There is provision on the network for the transmission of data to receiving display stations from other display stations and resources, step 83. Under normal operating conditions, this transmitted data is displayed in the form of messages superimposed upon the desktop or workspace of the program being run on the receiving display station, step 84.

This invention further provides for the enablement of a user installing an application program to designate the program as “Not to be Disturbed”, step 85. Then, step 86, provides for an implementation preventing the transmitted data of step 84 from being displayed on the receiving display station when the receiving display station is running a program designated as “Not to be Disturbed” in step 85.

Finally, provision is made for a display expedient for notifying a user if the display station is running a program in the “Not to be Disturbed”, step 87.

The running of the process will now be described with respect to FIG. 8. First, step 90, when a new program is being loaded into the computer controlled display station, the user is prompted as to whether the program is to be “Do Not Disturb”, step 91. If Yes, the program is set up to operate in the Do Not Disturb mode, step 92, and listed in the scrollable program list with the associated bar-circle icon, step 93. Otherwise, the program is normally listed with the associated icon. Then, during the operation of a display station, when a message arrives, step 94, first a determination is made as to whether any program is running on the receiving display, step 95. If No, all messages in a display buffer are displayed, step 97. In this connection, it should be noted that at any point in a session, there may be several accumulated messages which arrived while a Do Not Disturb program was running. Such messages may conveniently be stored in a buffer maintained within the storage buffer associated with the browser. If the decision from step 95 is Yes, then a further determination is made, step 96, as to whether the program is running in the “Do Not Disturb” mode. If No, the messages in the buffer are displayed, step 97. If Yes, a counter that keeps track of the total number of programs active and running in the Do Not Disturb mode is increased by “1”, step 98. Since several programs may be simultaneously running, this counter keeps track of the number of programs currently running in the Do Not Disturb mode. A “Do Not Disturb” icon is displayed, step 99, on the desktop or workspace (FIG. 6), and the display of the incoming message is prevented, step 100. Steps 99 and 100 may already be in effect if the program is receiving its first message, and another program in a multiprogram environment is already running in a Do Not Disturb mode. The message is then put into the messages buffer, step 101.

At this point, a determination is made as to whether the running of the program has been completed, step 102. If No, the running continues. If Yes, the Do Not Disturb program counter is decreased by “1”, step 103, and a determination is made as to Whether this counter is down to “0”, step 104, which would indicate that there are no Do Not Disturb programs running. If No, the process is returned to step 102 via branch “A”; if Yes, then a further determination is made as to whether the session is over, step 105. If Yes, the session is exited. If No, the session is branched back to step 95 via branch “B”.

One skilled in the art should appreciate that the processes controlling the present invention are capable of being distributed in the form of computer readable media in a variety of forms.

Although certain preferred embodiments have been shown and described, it will be understood that many changes and modifications may be made therein without departing from the scope and intent of the appended claims.

What is claimed is:

1. In a computer managed network of a plurality of data processor controlled interactive display stations, a system for selectively preventing data transmitted to a receiving display station from intruding on selected programs running on the user interface display of said receiving display station comprising:
means for loading programs into said receiving display station;
means enabling an interactive user at said receiving display station to designate any of said loaded programs as not to be disturbed;
means for running any of said loaded programs on said receiving display station;
means for transmitting data to be displayed on said receiving display station during the running of any of said loaded programs; and
means for preventing said transmitted data from being displayed when said program being run has been designated as not to be disturbed.

2. The computer managed network of claim 1 further including:
a plurality of computer resources connected to said network and shared by said interactive display stations; and
wherein said transmitted data relates to said shared computer resources.

3. The computer managed network of claim 2 wherein said means enabling said interactive user to designate a loaded program as not to be disturbed includes means for applying said not to be disturbed designation as a default attribute as said program is being loaded.

4. The computer managed network of claim 3 wherein one of said shared resources is an instant messaging system whereby any one of the other interactive display stations is enabled to transmit said data to be displayed in the form of an electronic message to said receiving display station.

5. The computer managed network of claim 3 wherein said transmitted data appropriates and persists in a portion of said user interface display unless prevented from being displayed.

6. The computer managed network of claim 4 further including a display element notifying the user when said display interface is running a program in the do not disturb mode.

7. The computer managed network of claim 2 wherein said network is the World Wide Web.

8. In a computer managed network of a plurality of data processor controlled interactive display stations, a method for selectively preventing data transmitted to a receiving display station from intruding on selected programs running on the user interface display of said receiving display station comprising:
loading programs into said receiving display station;
enabling an interactive user at said receiving display station to designate any of said loaded programs as not to be disturbed;
running any of said loaded programs on said receiving display station;
transmitting data to be displayed on said receiving display station during the running of any of said loaded programs; and
preventing said transmitted data from being displayed when said program being run has been designated as not to be disturbed.

9. The method of claim 8 wherein:
said network further includes a plurality of computer resources connected to said network and shared by said interactive display stations; and
said transmitted data relates to said shared computer resources.

10. The method of claim 9 wherein said step of enabling said interactive user to designate a loaded program as not to be disturbed includes the step of applying said not to be disturbed designation as a default attribute as said program is being loaded.

11. The method of claim 10 wherein one of said shared resources is instant messaging whereby any one of the other interactive display stations is enabled to transmit said data to be displayed in the form of an electronic message to said receiving display station.

12. The method of claim 10 wherein said transmitted data appropriates and persists in a portion of said user interface display unless prevented from being displayed.

13. The method of claim 11 further including the step of displaying a notification when said display interface is running a program in the do not disturb mode.

14. The method of claim 9 wherein said network is the World Wide Web.

15. A computer program having code recorded on a computer readable medium for selectively preventing data transmitted to a receiving display station from intruding on selected programs running on the user interface display of said receiving display station in a computer managed network of a plurality of data processor controlled interactive display stations, said computer program comprising:
means for loading programs into said receiving display station;
means enabling an interactive user at said receiving display station to designate any of said loaded programs as not to be disturbed;
means for running any of said loaded programs on said receiving display station;
means for transmitting data to be displayed on said receiving display station during the running of any of said loaded programs; and
means for preventing said transmitted data from being displayed when said program being run has been designated as not to be disturbed.

16. The computer program of claim 15 wherein said network further includes:
a plurality of computer resources connected to said network and shared by said interactive display stations; and
wherein said transmitted data relates to said shared computer resources.

17. The computer program of claim 16 wherein said means enabling said interactive user to designate a loaded program as not to be disturbed includes means for applying said not to be disturbed designation as a default attribute as said program is being loaded.

18. The computer program of claim 17 wherein one of said shared resources is an instant messaging system whereby any one of the other interactive display stations is enabled to transmit said data to be displayed in the form of an electronic message to said receiving display station.

19. The computer program of claim 17 wherein said transmitted data appropriates and persists in a portion of said user interface display unless prevented from being displayed.

20. The computer program of claim 18 further including a display element notifying the user when said display interface is running a program in the do not disturb mode.

21. The computer program of claim 16 wherein said network is the World Wide Web.

22. In a computer managed network of a plurality of data processor controlled interactive display stations, display apparatus for selectively preventing data transmitted to a receiving display station from intruding on selected programs running on the user interface display of said receiving display station comprising:
apparatus for loading programs into said receiving display station;
an interactive implement enabling a user at said receiving display station to designate any of said loaded programs as not to be disturbed;
apparatus for running any of said loaded programs on said receiving display station;
apparatus for transmitting data to be displayed on said receiving display station during the,running of any of said loaded programs; and
apparatus for preventing said transmitted data from being displayed when said program being run has been designated as not to be disturbed.

23. The computer managed network of claim 22 further including:
a plurality of computer resources connected to said network and shared by said interactive display stations; and
wherein said transmitted data relates to said shared computer resources.

24. The computer managed network of claim 23 wherein said implement enabling said interactive user to designate a loaded program as not to be disturbed applies said not to be disturbed designation as a default attribute as said program is being loaded.

25. The computer managed network of claim 24 wherein one of said shared resources is an instant messaging system whereby any one of the other interactive display stations is enabled to transmit said data to be displayed in the form of an electronic message to said receiving display station.

26. The computer managed network of claim 24 wherein said transmitted data appropriates and persists in a portion of said user interface display unless prevented from being displayed.

27. The computer managed network of claim 25 further including a display element notifying the user when said display interface is running a program in the do not disturb mode.

28. The computer managed network of claim 23 wherein said network is the World Wide Web.
